(19) United States
(12) Patent Application Publication
(10) Pub. No.: US 2011/0268239 A1
(43) Pub. Date: Nov. 3, 2011

(54) METHOD OF CALIBRATING EXCORE DETECTORS IN A NUCLEAR REACTOR

(76) Inventor: David Jerome Krieg, Pittsburgh, PA (US)

(21) Appl. No.: 12/770,870

(22) Filed: Apr. 30, 2010

(51) Int. Cl. G21C 17/108

(52) U.S. Cl. 376/254

(57) ABSTRACT

A method of calibrating excore detectors for a pressurized water reactor (PWR) includes: measuring peripheral core flux signals using excore detectors disposed at a plurality of locations spaced about the periphery of the core, and using the measured power distribution from either a core monitoring system or in-core flux measurement. Calibration of the excore detectors is broken into two parts: (1) the relation between the excore detector signal and weighted peripheral assembly axial offset, and (2) the relation between weighted peripheral assembly axial offset and core average axial offset. Relation (2) can be determined by a representative neutronics model. Accuracy of the neutronics solution is improved by applying nodal calibration factors, which represent the ratio of the measured three-dimensional power distribution to the nodal predicted three-dimensional power distribution and correct the neutronic results to match what would be measured if predictive scenarios were actually performed in the actual reactor core.

### BACKGROUND

1. Field

The disclosed concept relates generally to nuclear reactors and, more particularly, to a method of calibrating excore power range detectors in a nuclear reactor, such as a pressurized water reactor (PWR).

2. Background Information

The core of a modern commercial nuclear power reactor is formed by numerous elongated fuel assemblies mounted within an upright reactor vessel. Pressurized coolant is circulated through the fuel assemblies to absorb heat generated by nuclear reactions in fissionable fuel contained in the assemblies. The distribution of power through the core is affected by a number of factors, such as the degree of insertion of control rods into the fuel assemblies. Accurately determining the power distribution is important to assure that reactor operating limits are not exceeded.

By way of example, one system which has been developed to determine the power distribution in a pressurized water reactor (PWR) is the Best Estimate Analysis for Core Operation—Nuclear (BEACON™) system. Among other benefits, BEACON, which is available by license from Westinghouse Electric Company LLC, having a place of business in Monroeville, Pa., provides the capability for continuous core monitoring in existing PWRs using instrumentation that is currently available. BEACON uses either a combination of exit thermocouples, excore power range detectors and the movable incore detector, or fixed incore detector systems, in combination with a reference three-dimensional power distribution to determine the measured power distribution of the core. Among the functions performed by BEACON are core monitoring, core analysis, reactivity balance, and incore detector signal processing and analysis including predictive functions such as on-line shutdown margin evaluations, estimated critical condition calculations, load maneuver simulation and excore detector calibration.

Excore detectors have traditionally been calibrated using either a multi-point or a single-point calibration technique that is based upon analysis of operational information from previous cycles or the current cycle. As will be discussed, both of these techniques have their own unique set of limitations.

Multi-point calibration generally involves running movable detectors (i.e., incore detectors) through instrumentation thimbles in some of the fuel assemblies to generate data. The collection of this data occurs at multiple frequent points during an intentionally induced axial power oscillation in the core. The data is then processed to produce multiple maps of core power distribution, each of which is referred to as a flux map. Together with the response of the excore detectors and the axial information from the flux map results, coefficients are derived to calibrate the excore detectors. Among other disadvantages, multi-point calibration is time-consuming and labor and cost-intensive. Specifically, to complete the data collection, utilities are forced to spend time at low power levels, to introduce xenon oscillations in the core, or both. This undesirably requires additional plant personnel and lost power generation. By way of example, acquiring data for three points during initial startup at a reduced power requires about 16 hours, and letting the core get to equilibrium requires about 24 hours. Moreover, some utilities have the further requirement that all data be reduced and dialed into the excore detectors before ascending to power, which can take several days. Additionally, while movable incore flux maps provide accurate core power distributions, they are performed relatively infrequently (e.g., during startup and at intervals of about once a month during operation of the reactor). This is because radioactive emissions and heat exposure of the incore detectors would result in premature malfunction if the detectors were employed on an ongoing basis during normal operation of the reactor. Due to concerns of an incore sensor becoming stuck in the core, it is also desirable to minimize the frequency with which the incore detectors must be inserted through the instrumentation thimbles.

Without BEACON, plant licensing requirements typically mandate that a power distribution measurement be taken at a frequency of no greater than 31 days. When BEACON is licensed at the plant, BEACON takes the place of a movable flux map in producing a measured power distribution. Accordingly, BEACON advantageously allows the plant to delay taking another movable flux map for up to six months.

In view of the foregoing disadvantages associated with multi-point calibration, it is desirable to perform a single point calibration. Single point calibration generally involves replacing an actual power oscillation that would be produced in the core, with a simulation of an oscillation, using a predictive neutronics solution model. The problem with such techniques is that the predictive model, under certain circumstances, may not accurately represent the physical core. For example, the measured and predicted power distributions may not match. A wide variety of factors can contribute to such inaccuracy. For example, several factors which can cause the predictive model to be inaccurate are asymmetric loading of fuel in the core, mismatch between actual and modeled reactivity of the assemblies, or a mismatch in assembly burnup due to a difference between the operated history of the core and the modeled history, and limitations in the neutronics solution methods. That is, the core is divided into generally equal segments (e.g., without limitation, quadrants or sextants), wherein any quadrant or sextant of the core that does not behave the same as the other quadrants or sextants results in asymmetry of the core.

Accordingly, an existing problem with known single-point techniques is that they are typically reliant upon underlying assumptions. One assumption is that the reactor core has been loaded symmetrically, as noted previously. Another assumption is that the nuclear power plant is consistently operated at full power all of the time. Although this is sometimes true where, for example as in the United States the output of other non-nuclear (e.g., coal-fired; fossil-fuel-based) plants is generally available to be increased or decreased, as necessary, to accommodate relatively short term variations in power consumption, other nuclear power plants are operated differently in other parts of the world. For example, in France where the majority of the power generation is from nuclear power plants, it is necessary to increase and decrease the output of the nuclear plants as power demands dictate or grid frequency requires. The differences in the assumed operation in the predictive model and the as-operated history of the actual core can lead to inaccuracies in the predictive model.

A change in reactor power core output to accommodate a change in electrical output of a power generating plant is referred to as load follow. It is generally well established that operating a nuclear reactor during load follow can result in a variety of different adverse operating conditions. Accordingly, many reactor vendors recommend operating the reactor at a constant power output without a load follow capability. This lack of versatility in plant operation limits the utility of reactors and requires that non-nuclear electric generating plants be sustained to maintain the differences in capacity required with load changes. As previously noted, this is not a viable option in some parts of the world where non-nuclear plants are not available to serve this function. Under such circumstances, an effective load follow capability must be established. This requires a core monitoring system that can accurately substantially reconstruct the flux pattern within the core so that variations therein can be compensated for, for example, before a xenon maldistribution results.

There is a need, therefore, to improve the accuracy of the simulated oscillation (e.g., predictive model) associated with single point calibration of the excore detectors.

Therefore, there is room for improvement in methods of calibrating excore detectors in nuclear reactors.

### SUMMARY

These needs and others are satisfied by the disclosed concept, which is directed to a method of employing core monitoring corrections (e.g., nodal calibration factors) to the predicted simulation for determining the relationship between peripheral assembly axial offset and core average axial offset. Thus, the existing excore monitoring system of a nuclear reactor can be employed to accurately model the power distribution within the core, under a variety of non-standard conditions (e.g., without limitation, transient core operating conditions; asymmetric fuel loading conditions; core tilts; neutronic model mis-matches).

As one aspect of the disclosed concept, nodal calibration factors, which are part of a core monitoring system, such as the Best Estimate Analysis for Core Operation—Nuclear (BEACON™), are utilized to resolve limitations in the predicted simulation with a single point excore calibration technique, thereby improving the accuracy of the peripheral-to-core average axial offset relationship and accommodating differences in power and axial offset in the different segments (e.g., without limitation, quadrants; sextants) of the core. The three-dimensional nodal calibration factors are generated by determining the ratio of the measured three-dimensional power distribution from either a single movable incore detector flux map or self-powered detector snapshot, and the three-dimensional predicted power distribution from the neutronics model. More specifically, a method of utilizing monitoring power distribution information in a core of a pressurized water reactor (PWR) to improve excore detector calibration is provided.

In accordance with one non-limiting example embodiment of the disclosed concept, the method comprises: providing a core monitoring system; providing a plurality of excore detectors; taking a single movable incore or fixed-incore flux map to generate nodal calibration factors and a reference point of the current excore detector response and measured peripheral axial offset, the nodal calibration factors being generated by dividing the measured three-dimensional power distribution from the flux map with the predicted power distribution at the same core conditions; performing calculations to simulate axial power oscillations including at least one of (a) performing a series of rod maneuvers, and (b) including a series of xenon oscillations, wherein the rod maneuvers and the xenon oscillations are used to change the axial offset; multiplying the nodal calibration factors with the resultant three-dimensional power distribution calculations to correct the predicted results to the expected measured results; and using the results to develop a relationship between the peripheral assembly axial offset and the core axial offset and the peripheral assembly axial offset and the excore detector response. The multiplying of the nodal calibration factors provides the accurate calibration of the excore detector response to core average axial offset.

The method may further include applying the previously generated nodal calibration factors and current monitored power distribution to subsequent calibration of the excore detectors. The nodal calibration factors are a valid representation of the expected differences between the measurement and prediction for a period of up to about six months. The excore detector calibration may be based upon nuclear data which is generated on-the-fly in the current cycle of the core, without requiring the plant to generate an incore flux map. The calibration may be preformed, for example and without limitation, during power ascension, at the beginning of life of the core, at the end of core life, while the core is operated at part power or while the core is operated at full power.

The disclosed methods are applicable to both reactors which have a movable incore monitoring system and reactors which have fixed incore detector systems, as well as reactors having a combination of both movable and fixed incore detector system(s).

### BRIEF DESCRIPTION OF THE DRAWINGS

A full understanding of the disclosed concept can be gained from the following description of the preferred embodiments when read in conjunction with the accompanying drawings in which:

FIG. 1 is a side elevation, partially in section and partially schematic view of a PWR and reactor core therefore, incorporating the disclosed concept;

FIG. 2 is a top plan schematic view of a map of the reactor core of FIG. 1, showing the relative positions of the fuel assemblies, the control rods and the excore detectors;

FIG. 3 is a schematic view of data flow for nodal calibration factor generation during normal operation of the PWR reactor core of FIG. 1, in accordance with the disclosed concept;

FIG. 4 is a schematic view of data flow for the power distribution monitoring during normal operation of the PWR reactor core of FIG. 1, in accordance with the disclosed concept; and

FIG. 5 is a schematic view of data flow during the excore calibration process, in accordance with the disclosed concept.

### DESCRIPTION OF THE PREFERRED EMBODIMENTS

For purposes of illustration, embodiments of the disclosed concept will be described as applied to calibration of excore detectors in pressurized water nuclear reactors (PWRs) having a movable incore detector system and employing the Best Estimate Analysis for Core Operation—Nuclear (BEACON™) core monitoring system, although it will become apparent that they could also be applied to PWRs employing a core monitoring system other than BEACON, and having a movable incore detector system, a fixed incore detector system, or a combination of both a movable incore detector system and a fixed incore detector system.

As employed herein, the term “nuclear data” refers to information and parameters representing the fuel assemblies and burnable absorbers in a nuclear core and expressly includes, but is not limited to, neutron flux, power, burnup, inlet temperature, outlet temperature, enthalpy, axial offset and combinations thereof.

As employed herein, the phrase “non-standard core conditions” refers to any scenario in which the core is not being operated under normal operating conditions (e.g., without limitation, substantially symmetrical fuel loading among the segments (e.g., without limitation, quadrants; sextants) of the reactor core; consistent operation at full power) and expressly includes, but is not limited to, asymmetrical core power, axial tilt, control rod drop, control rod withdrawal, changes in cycle length, changes in the fuel loading pattern and replacement of an excore detector.

As employed herein, the term “nodal” refers to a method of decomposing the reactor core into subregions.

As employed herein, the term “number” shall mean one or an integer greater than one (i.e., a plurality).

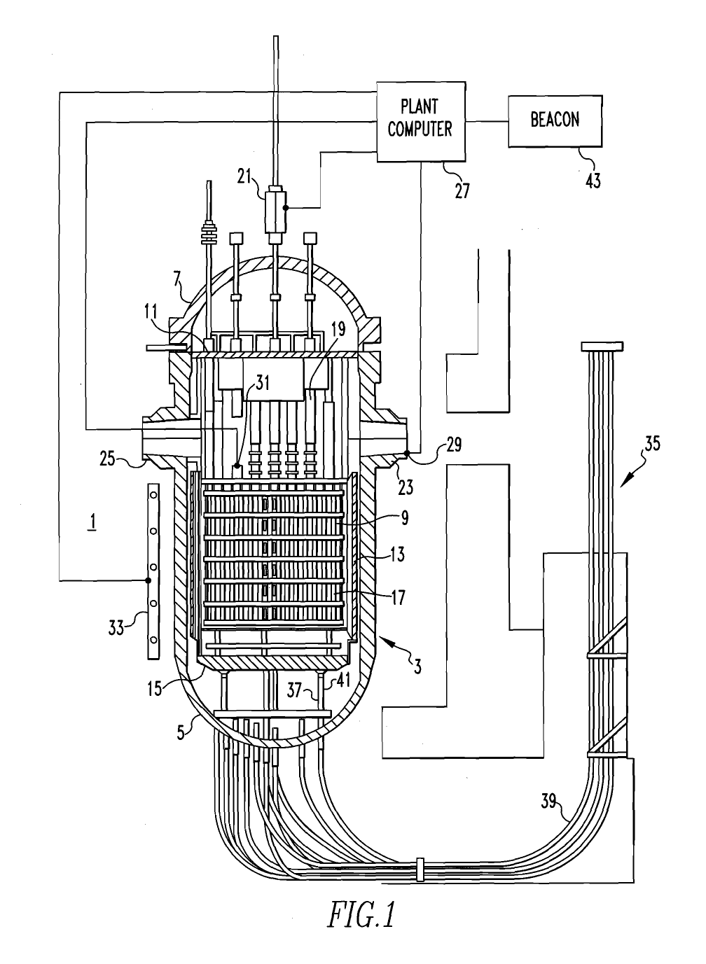

FIG. 1 illustrates a pressurized water reactor (PWR) 1, which includes an upright cylindrical pressure vessel 3 with a hemispherical bottom 5 and top lid 7. A reactor core 9 is suspended within the reactor vessel 3 by a structure which includes an upper support plate 11, a core barrel 13 and a lower support plate 15. The reactor core 9 is made up of a plurality of elongated fuel assemblies 17, each including fissionable material contained within a number of fuel rods (not shown). Clusters of control rods 19, each positioned by a drive mechanism 21 located above the lid 7, are inserted into the fuel assemblies 17 as one mechanism for controlling the reactivity of the fissionable material. Reactor coolant, which is circulated by reactor coolant pumps (not shown) enters an inlet nozzle 23, flows down around the core barrel 13, upward through the lower support plate 15, and passes upward through the fuel assemblies 17 where it is heated by the nuclear reactions within the fissionable material. Then the heated coolant, which is typically maintained at a pressure of about 2,250 psi by the reactor coolant pumps, passes outward through the outlet nozzle 25 for circulation through steam generators (not shown), where it gives up heat before returning to the inlet nozzle 23. Although only one is shown in FIG. 1 for simplicity of illustration, a reactor 1 will typically have between two to four loops, each having an inlet nozzle (e.g., 23) and an outlet nozzle (e.g., 25).

Various parameters of the foregoing process are monitored by a plant computer 27. Among such parameters are the inlet temperature of the coolant measured by thermocouples 29 at each of the inlets 23, and the temperature of the coolant as it leaves the fuel assemblies 17, which is measured by the exit thermocouples 31. Additional measurements include axial power offset, which is measured by a plurality of excore power detectors 33 disposed proximate the exterior of the reactor vessel 3, and numerous other parameters, which are not expressly identified herein, but which are also monitored or can be monitored by the plant computer 27.

The PWR 1 shown in the example of FIG. 1 is also equipped with a movable incore detector system 35, which includes a number of movable neutron detectors 37 (i.e., incore detectors), each mounted on a drive cable 39 that is pushed through a thimble guide tube 41. In this manner, the incore detectors 37 are moved through the fuel assemblies 17 in thimbles (not shown). Measurements taken by the incore detectors 37 are used to generate a flux map, which is an accurate measure of power distribution within the reactor core 9. However, as previously mentioned, these detectors 37 are used on a limited basis (e.g., a startup; at periodic spaced intervals during plant operation). Therefore, other mechanisms are needed to determine the power distribution within the reactor core 9 between flux mappings.

The PWR 1 utilizes a core monitoring system or processor 43 (shown in simplified form in FIG. 1) to continuously monitor core power distribution. The PWR 1 preferably, although not necessarily, employs BEACON as the core monitoring system 43. The core monitoring system 43 may include one or more engineering workstations (not shown). BEACON 43 uses the plant instrumentation (e.g., without limitation, movable incore detector system 35) together with a three-dimensional model of the reactor core 9 to continually provide a three-dimensional measured power distribution within the reactor core 9. As will be discussed hereinbelow, the BEACON three-dimensional nodal model power is updated for actual conditions, including under non-standard core conditions, as defined herein, by calibrating the excore detectors 33 using a single point calibration technique.

The advantage of BEACON 43 is that a measured power distribution can be employed, as monitored by BEACON 43, instead of exercising the incore detector system 35 and requiring a flux map to be generated. That is, for BEACON monitoring, the excore detectors 33 do not necessarily need to be calibrated, as BEACON 43 uses a more primitive response that utilizes raw signals and not the calibrated signals. Thus, BEACON 43 can function independent of the calibrated excore detector signals because the excore detectors 33 are not being used to determine the core axial offset, but rather to determine what the peripheral core power is. Stated another way, in a plant with BEACON 43, the only real purpose for the movable incore flux map is to calibrate BEACON 43. Thus, BEACON 43 becomes the replacement for using the movable incore detector system 35 to produce a measured power distribution. This measured power distribution becomes the reference for the method of calibrating the excore power detectors 33, in accordance with the disclosed concept.

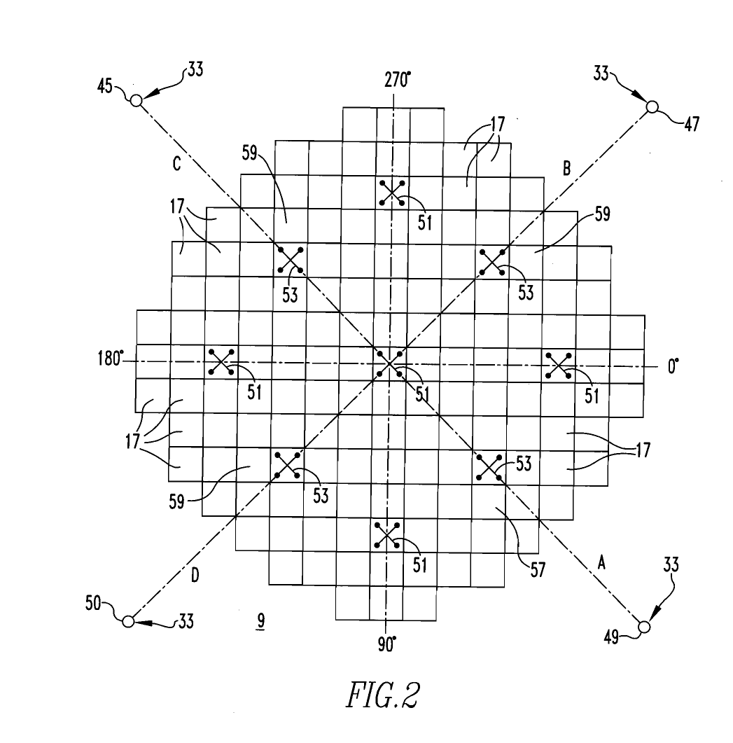

FIG. 2 is a top plan illustration of a portion of the PWR 1 of FIG. 1, which schematically shows the locations of the fuel assemblies 17, some of the control rods 19 (FIG. 1), and the excore detectors 33, in accordance with one non-limiting example embodiment of the disclosed concept. The core locations 51 and 53, respectively identify the full length control rod locations employed in one illustrative example of core operation. The remaining core locations 59 generally refer to fuel assembly positions, with some positions being reserved for other control applications. The reactor core 9 in the example of FIG. 2 has four equally sized quadrants A, B, C and D, and the overall shape of the core 9 is generally a square or diamond, depending on the top plan perspective from which it is observed. It will, however, be appreciated that the method of the disclosed concept is also applicable to cores (not shown) having any other known or suitable number and/or configuration of segments (e.g., without limitation, six segments or sextants) and/or overall shape (e.g., without limitation, generally hexagonal).

Fuel Assemblies are typically reloaded into the core 9 as symmetric partners. Symmetric assembly partners are typically in groups of four or eight assemblies, which in the previous fuel cycle were located in symmetric locations. By way of example, sometimes a symmetric partner can be damaged and will not be reloaded into the next fuel cycle. Rather, the damaged assembly will be replaced with another assembly from the spent fuel inventory. However, in the example of FIG. 2, the enrichment and flux exposure (i.e. burnup), for example, of fuel assemblies 57, 59 are different in each of the quadrants A, B, C, D of the core 9. It will be appreciated that FIG. 2 is merely meant to illustratively depict one non-limiting example of asymmetry of the core 9. Such asymmetry represents one-non-limiting example of the various non-standard core conditions, as defined herein, which the disclosed method can address and accommodate.

During operation, the inferred axial power distribution in the core 9 is monitored at a plurality of locations, such as for example and without limitation, excore detector locations 45, 47, 49, 50 of FIG. 2, which are symmetrically positioned around the periphery of the vessel 3 (FIG. 1). Each excore detector 33 provides corresponding flux information on the adjacent quadrant A, B, C, D of the core 9. Although, the core 9 is shown in this particular embodiment as being separated into quadrants A, B, C, D by the detectors 33 located on core diagonals, it will be appreciated that the quadrants A, B, C, D could also be defined by locating the detectors 33 on the core flats at the 0 degree, 90 degree, 180 degree and 270 degree locations. It will also be appreciated that the method of the disclosed concept is also applicable to excore detector channels, which are composed of two or more axial segments.

In the embodiment illustrated, the flux measurements detected by the detector 33 at location 45 are representative of the power generated in the core quadrant, B, bounded by the 0 degree axis and the 270 degree axis, each of which bisects the horizontal plane of the plan view illustrated in FIG. 2 and should be distinguished from the vertical core axis over which the axial flux profile is measured. Likewise, in FIG. 2, quadrant A is bounded by the 90 degree axis and the 0 degree axis, quadrant C is bounded by the 270 degree and the 180 degree axis, and quadrant D is bounded by the 180 degree axis and the 90 degree axis. When the core components (e.g., fuel assemblies 17 and control rods 19 of FIG. 1) of the core 9 are asymmetrically arranged for example, as noted above, the relationship between the peripheral fuel assemblies 17 and the average power in each quadrant A, B, C, D of the core 9 will not be identical.

Axial offset is a useful parameter for measuring the axial power distribution and is defined as:

Ao=(Pt−Pb)/(Pt+Pb)

where:
Pt is the fraction of power generated in the top half of the core 9; and
Pb is the fraction of power generated in the bottom half of the core 9, as measured generally by axially aligned excore detectors 33 positioned around the periphery of the reactor 1.
   If the core 9 will not be symmetrical, BEACON 43 (FIG. 1) can be modified in accordance with the disclosed concept to support the addition of core segment dependent (e.g., without limitation, quadrant-dependent; sextant-dependent) values. Those values can then be used to accurately update the power distribution in accordance with the calculations set forth hereinbelow.

Specifically, the single point calculation in accordance with the disclosed concept involves three calculations. The first calculation is to develop the relationship between the axial offset from the raw excore detector signals and the peripheral weighted core axial offset, AOpp. These are referred to as the “coupling coefficients,” and are designated A1 and A2 in expression (1) below. The second calculation is to develop the relationship between the core average axial offset, AO, and the peripheral weighted axial offset, AOpp. The third calculation is to adjust the values of a single measurement and provide the excore calibration constants and setpoints, K and Ko.

More specifically, the coupling coefficients, A1 and A2, which are created by the first calculation, (1), are derived during the initial implementation of a state point by using the results of processed flux maps during an axial xenon oscillation. In future single point analysis in accordance with the disclosed concept, the same coefficients can be used. The coupling coefficients, A1 and A2, are defined by the following expression:

In=A1*AOpp+A2 (1)

where:
In is the normalized current;
AOpp is the weighted peripheral axial offset; and
A1 and A2 are the coupling coefficients.
   Each of the terms in expression (1) is detector dependent. That is, for a typical reactor with four channels, In, A1 and A2 will be indexed by channel and by top and bottom of the core 9. The AOpp value is for both the top and bottom for a particular channel. Accordingly, for a quadrant setup (e.g., quadrants A, B, C, D) there would be eight different equations.

The second calculation (see expression (2) hereinbelow), which provides the relationship between the core average axial offset, AO, and the weighted peripheral axial offset, AOpp, is preferably determined by a series of rod maneuvers and/or a series of xenon oscillation calculations using the neutronics model at the required burnup of the calibration. The nodal calibration factors are applied to the results of these calculations. Among other benefits, this calculation eliminates the need to perform multiple flux maps during an axial xenon oscillation, as required in known multi-point calibration methods. The rod maneuvers and xenon oscillations are used to change the axial offset in the design calculation (see expression (1) hereinabove), and the slope constant, K, values are determined for each type of event in accordance with the following expression:

AOpp=K*AO−Ko (2)

where:
AOpp is the weighted peripheral axial offset;
AO is the core average axial offset;
K is the slope constant for converting core average axial offset to peripheral axial offset; and
Ko is the offset constant for converting core average axial offset to peripheral offset.
   In expression (2), there will be one equation for each channel. Thus, in the same four channel example discussed hereinabove with respect to expression (1), there will be four equations for the four quadrant (e.g., A, B, C, D) setup. K and Ko are collectively referred to as the “design constants”. AOpp, K, and Ko will be different for each channel, whereas AO is for the core 9.

The third calculation combines the results of the first two calculations, in order to tie the relationship from core average axial offset, AO, to the peripheral weighted axial offset, AOpp, to the excore detector response, by providing a single point where a true measurement is known. This allows the constant value, Ko, in the relationship between peripheral weighted axial offset, AOpp, and core average axial offset, AO, to be normalized. Thus, among other benefits, the disclosed method provides K and Ko constants for each segment (e.g., without limitation, quadrant; sextant) of the core 9. This is a significant advancement over previously known methods which produced only one set of constants for the core 9. In this manner, the disclosed concept addresses the fact that each segment (e.g., quadrants A,B,C,D of FIG. 2) of the core 9 may behave differently.

In view of the foregoing, it will be appreciated that the disclosed method overcomes the disadvantages that have traditionally existed with respect to conventional single point analysis by improving the accuracy of the replacement simulated oscillation of the predictive model used in the analysis, thereby improving the results of the analysis. In particular, BEACON 43 contains information that, when used in accordance with the method of the disclosed concept, can resolve the foregoing limitations in the calculation of the relationship between peripheral and core average axial offset (see second expression (2) hereinabove). Specifically, when a flux map is processed within BEACON 43, BEACON 43 generates what are referred to as nodal calibration factors. The nodal calibration factors, for each neutronic node in the core 9, reflect the relationship between the measured three-dimensional core power distribution and predicted three-dimensional power distribution.

The nodal calibration factors can be applied in the single point methodology using two different approaches. The first approach is to perform the complete xenon oscillation and/or rod maneuver, and then apply the nodal calibration factors to the resultant power distributions from those calculations. This greatly improves the results from the single point calibration when differences exist between the measured and predicted power distributions. The second approach is to perform the xenon oscillation and/or rod maneuver while applying the nodal calibration factors to each time step of the calculation. The nodal calibration factors are thus applied to the power and flux distribution. The corrected flux is then used to deplete xenon and iodine in the next time step. This approach corrects the secondary effects of the incorrectly predicted power on the changes in xenon during the oscillation. The power distributions from these corrected results can then be used in the calculations of K and Ko, in expression (2) above.

In summary, the method of the disclosed concept defines nodal calibration factors to accurately update the BEACON three-dimensional analytical nodal model power, even under non-standard core conditions. In instances where there is a movable incore detector system 35 (FIG. 1), BEACON 43 utilizes, in addition to other signals, responses from the thermocouples 31 (FIG. 1) and signals from the excore detectors 33. In instances where there is a fixed incore detector system (not shown), BEACON 43 does not utilize thermocouples (e.g., thermocouples 31 of FIG. 1) or excore signals for input to the monitoring process. Rather, these signals are replaced by fixed incore detector signals. In either case, with the movable incore detector system 35 or the fixed incore detector system (not shown), the monitoring process produces a monitored or measured (e.g., reference) three-dimensional power distribution. It is this measured power distribution that is necessary to calibrate the excore detectors 33 in the absence of a flux map, and it is this monitoring process that establishes the nodal calibration factors that are applied to the predictive model (e.g., calculation) in the oscillation simulation in accordance with the disclosed single point method.

Specifically, the nodal calibration factors are determined in accordance with the following expression:

C(i,j,k)=P^{M}(i,j,k)/P^{P}(i,j,k) (3)

where:
C is the nodal calibration factor;
P^{M} is the measured power;
P^{P} is the predicted power; and
i,j,k represent the spatial coordinates within the reactor core.

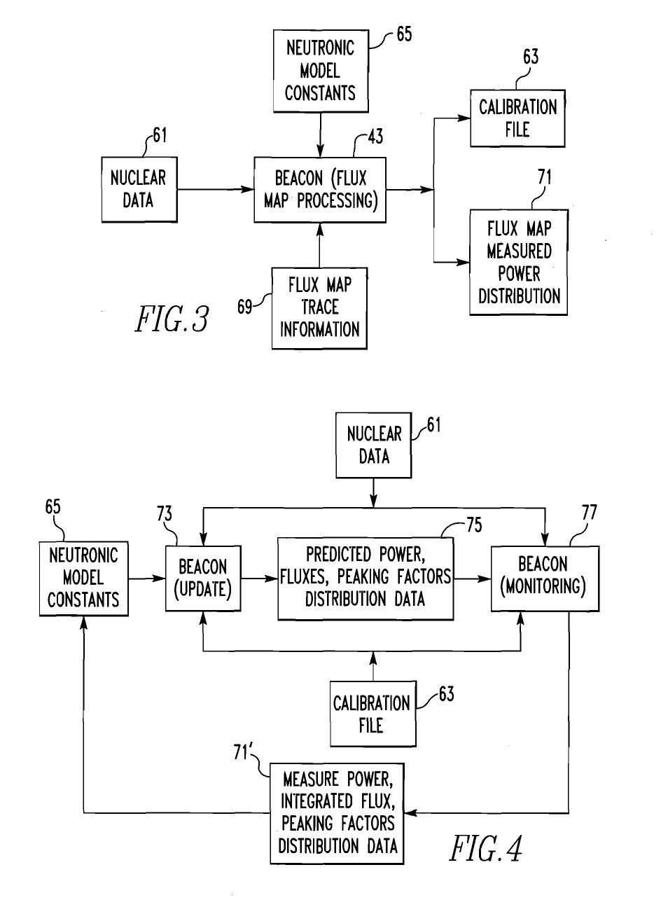

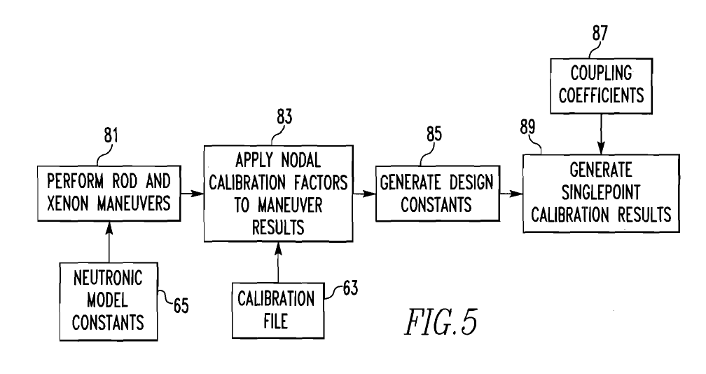

For a core 9 with a movable incore detector system 35 as shown in FIG. 1, the nodal calibration factors, C, are created only when an actual flux map is processed, as shown schematically in the flow chart of FIG. 3. In other words, the same nodal calibration factors (e.g., calibration file 63) are used until a decision is made to recalibrate BEACON 43. Specifically, during incore flux map processing 43, interactive analysis of the processed data 61 can be performed to analyze and evaluate the flux map. This interactive analysis, which is schematically shown in FIG. 3, includes collecting incore instrumentation signals (collectively referred to in FIG. 3 as flux trace information 69) from the incore detector system 35 (FIG. 1) and collecting nuclear data 61 (e.g., without limitation, core power level; pressure; thermocouples; excore detectors). Using this data 61,69, which represents the current state of the core, and neutronic model constants 65, BEACON 43 generates analytical predicted flux reaction rates at the exact condition of the flux map. The ratio of the BEACON calculated reaction rate to the measured reaction rate is the model accuracy. The inferred measured power distribution 71 is obtained using a combination of regression analysis and surface spline fits. During the BEACON 43 processing of the flux map, the nodal calibration factors 63 are obtained by using the ratio of the inferred measured power distribution 71 and predicted power distribution 75 (FIG. 4). If necessary, or if desired, BEACON 43 can also calculate a mixing factor to calibrate the thermocouple readings to incore measured power distributions as disclosed, for example, in commonly assigned U.S. Pat. No. 6,493,412. In processing the flux trace information 69 (FIG. 3), BEACON 43 allows, for example and without limitation, trace comparisons, visual trace grid alignment, detector drift analysis, symmetric trace comparisons, and the difference between measured and predicted reaction rates.

For a core (not shown) with fixed incore detectors (not shown), a set of nodal calibration factors, C, can be determined at any time, because signals are continuously being provided by the fixed incore detectors (not shown). In any event, the nodal calibration factors, C, are the ratio of the measured power in each node, P^{M}, divided by the predicted power in each node, P^{P}, as set forth in expression (3) hereinabove.

FIG. 4 illustrates data flow during normal operation of the reactor 1 (FIG. 1). An UPDATE background process 73, which is run in the core monitoring system 43 (FIG. 1; see also BEACON in FIG. 4) executes and depletes the analytical nodal model represented by the neutronic model constants 65. The UPDATE process 73 has access to nuclear data 61 from the reactor instrumentation (e.g., without limitation, thermocouples; incore detectors; excore detectors). The UPDATE process 73 determines the predicted power for each fuel assembly 17 (FIGS. 1 and 2) from the analytical nodal model. The nuclear data file 61 may contain, for example and without limitation, inlet thermocouple temperatures, exit thermocouple temperatures, core power level, control rod positions, excore detector signals and pressure. At least some of this data 61 may, for example, be collected periodically during initial power ascension of the plant, while other data 61 is continuously collected and updated throughout operation of the core 9 (FIGS. 1 and 2). A calibration file 63, which includes such things as the aforementioned thermocouple mixing factor functions and the excore detector calibration factors, as well as nodal calibration factors, standard deviation function coefficients, date and time of the calibration and other calibration parameters. The UPDATE process 73 combines the predicted power distribution with the nodal calibration factors 63 to produce an expected three-dimensional (3D) power distribution 75. The BEACON MONITORING process 77 uses this expected power distribution 75 along with the latest nuclear data 61, which includes excore detector signals, to generate the measured power distribution information 71′. The measured power distribution information 71′, preferably provided by BEACON, is substantially equivalent to the measured power distribution 71 produced by the flux map process previously described hereinabove with respect to FIG. 3. For excore detector calibration, these, on-the-fly power distribution measurements can also be used in place of a flux map.

Periodically during initial power ascension (e.g., without limitation, at 30%, 50%, 75% and 100% power) and/or during normal operation, a flux map measurement is made, as illustrated schematically in FIG. 3, and a full excore detector calibration is performed as shown in FIG. 5. The BEACON 43 (FIG. 1; see also FIGS. 3 and 4) foreground process is the interface used to generate the calibration information (e.g., without limitation, nodal calibration factors) of the calibration file 63. Specifically, the data required for this phase is the information collected from the aforementioned single point calibration calculations, which is used to generate the excore detector calibration factors 63 for each excore detector 33 (FIGS. 1 and 2). These are then calibrated factors 63 fitted to the selected fitting function, and adjusted using the flux map data stored in a flux map file 69 (FIG. 3). Unique to the disclosed method is that during calibration, interactive analysis of the processed data in the flux map file 69 is performed to evaluate the flux map, as described above. Included in this process are the aforementioned axial offset calculations. When data from the flux map file 69 is processed within BEACON 43 (FIG. 1; see also FIGS. 3 and 4), BEACON 43 generates the aforementioned nodal calibration factors, C (see expression (3) hereinabove), for each neutronic node in the core 9 (FIGS. 1 and 2). As noted previously, these nodal calibration factors, C, are representative of the relationship between the measured power 71 and predicted power distribution 75.

As shown in FIG. 5, the process of performing a single point calibration involves the analytical nodal model using the neutronic model constants 65 to generate the appropriate predicted xenon and rod maneuvers calculations 81. Next, at step 83, the resultant three-dimensional (3D) power distribution from the maneuvers are corrected by the nodal calibration factors 63, which were generated as shown in FIG. 3 and used in BEACON for measurement correction, as shown in FIG. 4. Once corrected, the design constants, K, Ko (see expression (2) described hereinabove), can be generated from step 85. The coupling coefficients, A1, A2 (see expression (1) previously described hereinabove), step 87, are then combined, at step 89, with the design constants, K, Ko, from step 85, and normalized to a single flux map 71 (FIG. 3) or to measured data produced by the BEACON monitoring process 71′ (FIG. 4). Hence, a single point calibrated measurement is achieved. In other words, as noted hereinabove, it will be appreciated that measured power distribution information via processing incore flux traces 71 (FIG. 3) can be suitably replaced with measured power distribution data via BEACON monitoring 71′ (FIG. 4).

Accordingly, the disclosed method provides an advanced flux map processing capability, which preferably, although not necessarily, uses BEACON 43

(FIG. 1; see also FIGS. 3 and 4). Specifically, the disclosed method utilizes the nodal calibration factors, C (see expression (3) hereinabove), which are part of BEACON 43, to resolve limitations that exist with known single point calibration techniques. Among other benefits, the enhancement improves the accuracy of the peripheral-to-core average axial offset relationship, while allowing for differences in power and axial offset in the different segments (e.g., without limitation, quadrants; sextants) of the reactor core 9. The disclosed excore calibration method also significantly reduces the amount of time and associated cost required for the calibration. It also affords advantages such as, for example and without limitation, advantageously reduce wear and tear on the incore flux mapping system 35 (FIG. 1), reduce water processing, reduce site personnel effort, and reduce possibility of an undesirable reactor trip near the end of life. Thus, not only does it provide for accurately modeling core power distribution, even under non-standard core conditions, but it also results in substantial financial savings.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A method of monitoring power distribution in a core of a pressurized water reactor, the method comprising:
providing a core monitoring system;
providing a plurality of excore detectors;
taking a single movable incore or fixed-incore flux map to generate nodal calibration factors and a reference point of the current excore detector response and measured peripheral axial offset, the nodal calibration factors being generated by dividing the measured three-dimensional power distribution from the flux map with the predicted power distribution at the same core conditions;
performing calculations to simulate axial power oscillations including at least one of (a) performing a series of rod maneuvers, and (b) performing a series of xenon oscillations, wherein the rod maneuvers and the xenon oscillations are used to change the axial offset;
multiplying the nodal calibration factors with the resultant three-dimensional power distribution calculations to correct the predicted results to the expected measured results; and
using the results to develop a relationship between the peripheral assembly axial offset and the core axial offset and the peripheral assembly axial offset and the excore detector response,
wherein the multiplying of the nodal calibration factors provides the accurate calibration of the excore detector response to core average axial offset.

2. The method of claim 1, further comprising:
determining the nodal calibration factors in accordance with the following expression:
C(i,j,k)=P^{M}(i,j,k)/P^{P}(i,j,k)
where:
C is the nodal calibration factor;
P^{M} is the measured power;
P^{P} is the predicted power; and
i,j,k represent the spatial coordinates within the reactor core.

3. The method of claim 1, wherein the monitoring system of the core comprises the Best Estimate Analysis for Core Operation—Nuclear (BEACON) system.

4. The method of claim 3, further comprising:
monitoring core power distribution using BEACON,
employing a single point calibration technique in combination with BEACON power distribution measurements to generate the calibration factors, and
applying the calibration factors to measure core power and axial power distribution of the core.

5. The method of claim 4, further comprising:
recalibrating BEACON.

6. The method of claim 1, further comprising:
the core having a centerline, a periphery and a plurality of equally sized segments extending about the centerline between the centerline and the periphery, and
updating the core monitoring system to accommodate conditions in which the core is asymmetrical about the centerline.

7. The method of claim 6, further comprising:
each of the segments of the core including a plurality of fuel assemblies, and
updating the core monitoring system to accommodate conditions in which the fuel assemblies are not loaded substantially similarly in each of the segments of the core.

8. The method of claim 1, further comprising:
generating measured core power distribution, on-the-fly, in the current cycle of the core, without requiring the core monitoring system to generate an incore flux map.

9. The method of claim 1, further comprising:
performing said calibration of the excore detectors during power ascension at the beginning of life of the core.

10. The method of claim 1, further comprising:
performing said calibration of the excore detectors while the core is being operated at full power.

11. The method of claim 1, further comprising:
performing a first calculation to develop a first relationship between axial offset from the excore detector flux signals, and peripheral weighted core axial offset,
responsive to performing the first calculation, developing coupling coefficients indicative of the first relationship,
performing a second calculation to develop a second relationship between core average axial offset and the peripheral weighted core axial offset, and
performing a third calculation to combine the first relationship and the second relationship.

12. The method of claim 11, further comprising:
calculating the coupling coefficients in accordance with the expression:
In=A1*AOpp+A2
where:
In is the normalized current,
AOpp is the weighted peripheral axial offset, and
A1 and A2 are the coupling coefficients.

13. The method of claim 11, further comprising:
calculating a number of design constants by performing the second calculation, including the step of performing at least one of (a) a series of rod maneuvers, and (b) a series of xenon oscillation calculations.

14. The method of claim 13, further comprising:
employing the rod maneuvers and xenon oscillation calculations to change the axial offset in the first calculation, and
determining a slope constant, K, for each type of event in accordance with the expression:
AOpp=K*AO−Ko
where:
AOpp is the weighted peripheral axial offset,
AO is the core average axial offset,
K is the slope constant for converting core average axial offset to peripheral axial offset, and
Ko is the offset constant for converting core average axial offset to peripheral offset.

15. The method of claim 11, further comprising:
the core having a centerline, a periphery and a plurality of equally sized segments extending about the centerline between the centerline and the periphery of the periphery,
responsive to the core being asymmetrically loaded with respect to the centerline of the core, the relationship between peripheral fuel assemblies of the core and average power of the core being different for the segments of the core, and
inputting segment-dependent values into the third calculation.

16. The method of claim 11, further comprising:
performing a xenon oscillation to generate resultant power distributions, and
subsequent to completing the xenon oscillation, applying the nodal calibration factors to the resultant power distributions, in order to process the flux signals.

17. The method of claim 11, further comprising:
performing a xenon oscillation at a plurality of predetermined time intervals, and
applying the nodal calibration factors incrementally at each time interval during the xenon oscillation to generate resultant power distributions.

18. The method of claim 11, further comprising:
performing a rod insertion maneuver to generate resultant power distributions, and
subsequent to completing the rod insertion maneuver, applying the nodal calibration factors to the resultant power distributions, in order to process the flux signals.

19. The method of claim 11, further comprising:
performing a rod insertion maneuver at a plurality of predetermined time intervals, and
applying the nodal calibration factors incrementally at each time interval during the rod insertion maneuver to generate resultant power distributions

20. The method of claim 1, further comprising the core monitoring system comprising one of a movable incore detector system and a fixed incore detector system.

21. The method of claim 13, further comprising:
employing one of a movable incore flux map and a measured power distribution from the core monitoring system to normalize the excore detector constants.
